(19) United States
(12) Patent Application Publication
(10) Pub. No.: US 2008/0017823 A1
(43) Pub. Date: Jan. 24, 2008

(54) Vacuum valve and closure disc which can be mounted on a connecting rod

(76) Inventor: Bernhard Litscher, Buchs (CH)

Correspondence Address: MG-IP Law, PLLC, P.O. BOX 1364, FAIRFAX, VA, 22038-1364, US

(21) Appl. No.: 11/879,501

(22) Filed: Jul. 18, 2007

(30) Foreign Application Priority Data
Jul. 18, 2006 (CH) 01159/06

(51) Int. Cl. F16K 25/00

(52) U.S. Cl. 251/193

(57) ABSTRACT

The invention relates to a vacuum valve (1) for the gas-tight closing of a flow path (F), comprising a closure disc (5) in which at least one rod recess (6) is formed, and at least one connecting rod (8). The closure disc (5) is removably mounted on the connecting rod (8) by positioning of the rod recess (6) on a connecting section (9) of the connecting rod (8) by means of a screw (16) which is led through a transverse bore (15) in the connecting section (9) and engages a threaded bore (14) in the rod recess (6). According to the invention, a projection (17) and a recess (18) are provided in the connecting region of the rod recess (6) and of the connecting section (9), the projection (17) and the recess (18) being formed in such a way that the projection (17) is gripped round by the recess (18) in a plane containing the connecting rod axis (19), and the closure disc (5) and the connecting rod (8) are fixed to one another in an interlocking manner in the directions of the displacement path (11). The invention makes it possible, after the initial firm tightening of the screw (16), to achieve self-orientation of the closure disc (5) relative to the connecting rods (8) in the directions of the displacement path (11) and to avoid relative movements between the valve disc (5) and the connecting rods (8) during operation.

The invention relates to a vacuum valve for gas-tight closure of a flow path by means of a closure disc mounted on at least one connecting rod, according to the pre-characterizing clause of Claim 1, and a closure disc according to the pre-characterizing clause of Claim 11.

Vacuum valves for substantially gas-tight closing of a flow path which leads through an opening in a valve housing are know in various embodiments from the prior art. Vacuum gate valves are used in particular in the area of IC and semiconductor manufacture, which has to take place in a protected atmosphere, as far as possible without the presence of contaminating particles. For example, in a manufacturing unit for semiconductor wafers or liquid crystal substrates, the highly sensitive semiconductor or liquid crystal elements pass sequentially through a plurality of process chambers in which the semiconductor elements present inside the process chamber are processed by means of a processing apparatus in each case. During the processing process inside the process chamber and during transport from process chamber to process chamber, the highly sensitive semiconductor elements must always be present in a protected atmosphere—in particular in a vacuum. The process chambers are connected to one another, for example, via connecting passages, it being possible for the process chambers to be opened for transferring the parts from one process chamber to the next by means of vacuum gate valves and to be closed gas-tight thereafter for carrying out the respective manufacturing step. Owing to the field of use described, such valves are also referred to as vacuum transfer valves and, owing to their rectangular opening cross-section, also as a rectangular gate valves.

Very different embodiments of vacuum valves, in particular the sealing and drive technologies thereof, are known from the prior art. Depending on the respective drive technologies, a distinction is made in particular between gate valves also referred to as valve gates or rectangular gate valves, and shuttle valves, the closing and opening in the prior art generally taking place in two steps. In a first step, a valve closure, in particular a closure disc, in the case of a gate valve, as disclosed, for example, in U.S. Pat. No. 6,416,037 (Geiser) or U.S. Pat. No. 6,056,266 (Blecha), is moved linearly over an opening substantially parallel to the valve seat or, in the case of a shuttle valve, as disclosed, for example, in U.S. Pat. No. 6,089,537 (Olmsted), is pivoted about a pivot axis over the opening without contact taking place between the closure disc and the valve seat of the valve housing as a result. In a second step, the closure disc is pressed with the closure side thereof onto the valve seat of the valve housing so that the opening is closed gas-tight. Sealing can be effected, for example, either via a sealing ring arranged on the closure side of the closure disc and pressed onto the valve seat running round the opening or via a sealing ring on the valve seat, against which the closure side of the closure disc is pressed.

Gate valves in which the closing and sealing process is effected via a single linear movement are also known. Such a valve is, for example, the transfer valve from VAT Vakuumventile A G in Haag, Switzerland, which is known by the product designation “MONOVAT series 02 and 03” and is designed as a rectangular insert valve. The design and the mode of operation of such a valve are described, for example, in U.S. Pat. No. 4,809,950 (Geiser) and U.S. Pat. No. 4,881,717 (Geiser). The valve described there has, in its housing, a sealing surface which, when viewed in the direction of the axis of the valve passage, has sections which are located one behind the other and become, via continuous curves, flat sealing surface sections running laterally outwards, imaginary generators of the sealing surface which is in one part but has a plurality of sections being parallel to the axis of the valve passage. The sealing surface is processed. The closure member has a contact surface corresponding thereto for the circumferentially closed seal. Described in more detail, the so-called valve gate has a gate housing and a gate passage which can be closed by a closure member displaceable in its plane. Provided in the region of the gate passage is a sealing surface against which the circumferentially closed seal arranged on the closure member rests in the closed position of said closure member, the imaginary, straight generators of the sealing surface being parallel to the axis of the gate passage. The circumferentially closed, one-piece seal has sections of different lengths and/or shapes which are in different planes, two main sections of the circumferentially closed seal being in planes which are at right angles to the axis of the gate passage and a distance apart. The two main sections of the seal are connected by lateral sections. The closure member has a surface corresponding to the contour of the sealing surface of the housing and carrying the circumferentially closed seal. The lateral sections of the circumferentially closed seal are U-shaped. In each case, the limbs of these U-shaped lateral sections are in a plane. Those sections of the sealing surface which are located one behind the other when viewed in the axial direction of the gate passage become flat sealing surface sections running laterally outwards for contact with the main sections of the seal in that region in which they have a common, straight generator parallel to the axis. These flat sealing surface sections are in planes parallel to one another and to the axis of the gate passage. Since the closure member comprises one part, it may be exposed to high acceleration forces so that this valve can also be used for fast and emergency closures. Since the closing and the sealing can be effected by means of a single linear movement, very fast closing and opening of the valve are possible.

A suitable drive for such a transfer valve which can be closed by means of a linear movement is described in JP 6241344 (Buriida Fuuberuto). The drive described there has eccentrically mounted levers for linear displacement of the connecting rods on which the closure member is mounted.

Since transfer valves are used, inter alia, in the production of highly sensitive semiconductor elements, the particle generation caused in particular by the actuation of the valve and the number of free particles in the valve space must be kept as low as possible. The particle generation is primarily a consequence of friction, for example by metal-metal contact, in particular between the valve closure and the valve housing or the valve seat, and the valve closure and the connecting rods on which the valve closure is fixed, and is thus associated with the drive.

A particular challenge for avoiding particle generation is the connection between the connecting rods of the valve drive and the valve closure, in particular the closure disc. The closure disc must be firmly connected to the connecting rod or connecting rods so that precise guidance in the valve housing and exact pressing of the closure disc onto the valve seat without unintended material contacts with simultaneously high load capacity of the closure disc in the closed state of the valve are possible. An unintended relative movement of the valve disc on the connecting rods can, owing to the resulting material friction, lead to production of abrasion particles which might contaminate the highly pure atmosphere in the valve space. The prior art therefore always strives for play-free, firm contact between connecting rod and closure disc. On the other hand, the closure disc has to be capable of being removed from the connecting rod, as far as possible without a major dismantling effort and of being reinstalled, for maintenance and/or for exchange. The required provision of a detachable connection is however in conflict with the desired avoidance of particle generation, since material contact with friction and the production of particles can be avoided only with considerable effort during removal of the closure disc from the connecting rods and installation of said closure disc. The danger of an unintended relative movement between the closure disc and the connecting rods is of course greater in the case of a detachable connection than in the case of a non-detachable connection, in the particular one achieved by fusion of material.

The prior art discloses that two open semi-circular recesses for two connecting rods can be provided on the back of the closure disc, and the connecting rods can be mounted by means of one screw each, which is led through one transverse bore in each case in the connecting rod and engages a threaded bore formed in the recess. The connection which is axial with respect to the connecting rod is effected both by frictional connection through the force which is applied via the screw and acts perpendicularly to the closure disc between the connecting rod and the recess and by interlocking connection via a shoulder-like step in the connecting rod, which step acts only in the closing direction. This step supports the connecting rod on the upper edge of the semi-circular recess on closing of the closure disc by means of the linear movement and pressing of the closure disc onto the valve seat.

Such fixing is used, for example, in the transfer valve from VAT Vakuumventile A G in Haag, Switzerland, which is known by the product designation “MONOVAT series 02 and 03” and designed as a rectangular insert valve. In order to permit exact orientation of the closure disc relative to the valve seat, the screws are initially not tightened after mounting of the closure disc, so that a relative movement between the connecting rods and the closure disc is still possible by overcoming the friction on closing of the valve. Subsequently, the valve is closed. Because the fixing between the connecting rods and the closure disc is still not definitive, the valve disc becomes oriented exactly towards the valve seat. Moreover, the connecting rods initially held by a frictional connection along the linear displacement path move relative to the closure disc until the shoulder-like step comes to rest firmly on the upper edge of the semi-circular recess and hence the closing force flux is effected via interlocking. In a subsequent step, the screws are tightened so that movement of the closure disc relative to the connecting rods is no longer possible. The two shoulder-like steps of the two connecting rods rest firmly on the upper edges of the semi-circular recesses and are fixed there by a frictional connection by tightening the screws. Since a large force acts on the connections between the connecting rods and the closure disc only in the linear closing direction, and this large force is absorbed through interlocking via the shoulder-like steps, the firm tightening of the screws results in no substantial displacements between the connecting rods and the closure disc, so that the production of material particles by friction during normal operation of the vacuum valve is kept relatively low. The particles produced before firm tightening of the screws through orientation on the connecting rods are removed by means of cleaning. Owing to the fixing of the closure disc on the connecting rods, no further particles are produced until the screws are loosened again.

A disadvantage of the known connection between the closure disc and the connecting rod is the relatively long time associated with the loosening and tightening of the screws and required for removing the closure disc from the connecting rods and installing it on the connecting rods. The two-stage tightening of the screws described above for exact orientation of the closure disc is a problem which could not be adequately solved by the connections known to date. A connecting element which can be operated faster and more conveniently and by means of which the closure disc is oriented exactly on the connecting rod directly after installation and even before the initial closing of the valve would be desirable in order to be able to prevent material friction and production of particles immediately after the installation of the closure disc on the connecting rods.

It is therefore an object of the invention to provide a vacuum valve closure disc which can be installed as far as possible exactly with self-orientation on the at least one connecting rod of the valve drive and removed again without great effort within a short time, the existence of free material particles within the valve space caused during the operation of the vacuum valve, being kept low.

This object is achieved by realising the characterizing features of the independent Claims. Features which further develop the invention in an alternative or advantageous manner are described in the dependent patent claims.

The vacuum valve serves for the gas-tight closing of a flow path, the flow path generally being understood as meaning a path which is to be closed and which is present between two regions—in particular between a process chamber for semiconductor manufacture and either a further process chamber or the outside. The flow path is, for example, a passage between two process chambers connected to one another, the process chambers being capable of being opened by means of the vacuum valve for transferring the semiconductor parts from one process chamber to the next and of being closed gas-tight after the respective manufacturing step has been carried out. Owing to the field of use described, such valves are also referred to as vacuum transfer valves and, owing to their generally rectangular opening cross-section, also as rectangular gate valves. However, any desired other use of the vacuum valve according to the invention for the substantially gas-tight closing of any desired flow path is of course also to be understood. The vacuum valve comprises a valve housing having an opening for the flow path. The opening is, for example, rectangular and has a central axis which extends in the region of the opening in the centre of the flow path and parallel thereto. This opening axis is, for example, perpendicular to the area defined by the opening. The opening is surrounded by a valve seat surface which curves around the opening within a plurality of imaginary planes through which the opening axis passes perpendicularly.

The vacuum valve comprises at least one connecting rod, in particular two connecting rods. The connecting rod is displaceable via a valve drive along a linear displacement path, which is parallel to the connecting rod axis, in an imaginary plane of the closure disc, the closure disc plane, which extends perpendicularly to the opening axis. The connecting rod axis is in particular parallel with or collinear with the central axis of the preferably straight connecting rod. The closure disc plane is substantially parallel to the area defined by the opening. The valve drive is formed, for example, from a valve drive known from the prior art. A suitable drive for such a vacuum valve closable by means of a linear movement is described in JP 6241344 (Buriida Fuuberuto). The valve drive described there has eccentrically mounted levers for linear displacement of the connecting rods. A connecting section having a transverse through-bore which is arranged centrally in the connecting section, substantially perpendicular to the closure disc plane, is formed at the end of the connecting rod.

The vacuum valve has a closure disc which is removably mounted on the at least one connecting rod. The closure disc has a closure surface corresponding to the valve seat surface. Corresponding is to be understood as meaning that the closure surface and the valve seat surface are formed in such a way that the closure disc can be pressed onto the closure surface by means of a linear movement which takes place substantially perpendicularly to the opening axis so that a sealing contact between the closure surface and the valve seat surface can be produced around the opening. On that side of the closure disc which faces away from the opening, at least one concave—in particular semi-circular—rod recess—in particular two rod recesses for two connecting rods—is or are formed. The rod recess corresponds to the connecting section of the connecting rod, so that it is possible to couple the connecting section to the rod recess. The rod recess has in particular a semi-circular channel shape in which the connecting section which is, for example, cylindrical and fits into the channel shape can be arranged. Moreover, a threaded bore which is arranged centrally in the rod recess, substantially perpendicularly to the closure disc plane, is provided in the closure disc. In particular, two connecting rods and two connecting rod recesses which are arranged parallel in the closure disc plane are provided.

The closure disc is removably mounted on the at least one connecting rod by positioning of the rod recess on the connecting section via a screw which is led through the transverse bore of the connecting rod, engages the threaded bore of the closure disc and presses the connecting section into the rod recess.

The geometrical normals to the at least partly curved valve seat surface and to the closure surface are substantially parallel to the closure disc plane. The closure disc is linearly displaceable by means of the valve drive along the displacement path between an opened position which in particular completely unblocks the opening and hence the flow path and a position which is closed substantially gas-tight and in which the closure disc is displaced linearly over the opening and hence presses with the closure surface substantially in the closing direction of the displacement path onto the valve seat surface. The geometrical normals are to be understood as meaning the perpendiculars to the contact area of the valve seat surface and of the closure surface, which contact area runs around the opening when the vacuum valve is in the closed state. This contact area is formed, for example, by the contact area of a sealing band of the closure surface and of the valve seat surface. In general, this definition is to be understood as meaning that the valve seat surface and the closure surface are formed in such a way that, on closing of the vacuum valve, along the linear closing direction, the pressing (i.e. the direction of the compressive forces) of the closure surface on to the valve seat surface takes place substantially in a plane which is substantially parallel to the plane of the closure disc so that shear forces in a direction parallel to the opening axis are completely or substantially avoided. The linear displacement path is the straight line between the opened and the closed position of the closure disc, preferably parallel to the connecting rod axis.

Such a vacuum valve is substantially disclosed in the prior art, for example as the rectangular insert valve developed and sold under the product name “MONOVAT series 02 and 03” by VAT Vakuumventile A G in Haag, Switzerland. The design and the mode of operation of such a valve are described, for example, in U.S. Pat. No. 4,809,950 (Geiser) and U.S. Pat. No. 4,881,717 (Geiser).

According to the invention, a projection and a recess are provided in the connecting region of the rod recess and of the connecting section, i.e. the region in which the two bodies are connected to one another. It is possible both for the projection to be arranged in the connecting section and the recess in the rod recess, and vice versa. Furthermore, it is possible for both the connecting section and the rod recess to each have at least one projection and one recess. The projection and the recess are formed in such a way that the projection is gripped around by the recess in a plane on which the connecting rod axis lies, and the closure disc and the connecting rod are fixed to one another by interlocking connection in the directions of the displacement path. Thus, by means of interlocking connection in the mounted state of the closure disc, it is not possible to move said disc in either of the two directions parallel to the connecting rod axis relative to the connecting rods, with the result that friction and hence the production of particles are avoided. Here, the screw presses the closure disc into the rod recess and hence the projection into the recess. As a result, the closure disc is centred relative to the connecting rod along the connecting rod axis in a position defined by the position of the projection and of the recess. The force between the connecting rod and the closure disc which acts on the valve seat surface as a result of pressing on the closure disc is transferred substantially by frictional connection by the projection and the recess. Thus, projection and recess perform two functions, namely that of force transmission and that of centring in the direction of the displacement path, so that the distance in the direction of the displacement path between the closure disc and the connecting rod and hence indirectly between the closure disc and the valve drive assumes a predetermined position unchangeable during operation through the mounting of the closure disc by means of the screw.

The connection according to the invention between the closure disc and the connecting rod makes it possible to implement the removal of the closure disc from the connecting rod and mounting of the closure disc on the connecting rod within a short time. The above-described two-stage tightening of the screws which is required in the prior art for exact orientation of the closure disc can be dispensed with since the orientation is effected after the first firm tightening of the screw. Directly after installation and even before the first closure of the valve, the closure disc is oriented exactly on the connecting rod so that, directly after the installation of the closure disc on the connecting rod, material friction and the production of particles can be prevented. The closure disc can be mounted exactly with self-orientation on the at least one connecting rod of the valve drive and removed again without great effort within a short time, the existence of free material particles within the valve space, which is caused during the operation of the vacuum valve, being kept low.

In a further development of the invention, the recess has a cross-section which tapers inwards into the recess in such a way that the closure disc is centred in an interlocking manner relative to the connecting rod in the directions of the displacement path as a result of pressing the projection into the recess by means of the screw. The projection and the recess are preferably arranged in a region between the threaded bore and that edge of the rod recess which points towards the valve drive, in particular close to this edge.

In an embodiment of the invention, the recess is in the form of a groove which runs in a plane perpendicular to the connecting rod axis. The groove has a cross-section tapering inwards into the groove in a substantially V-shaped manner. Alternatively, the recess is in the form of a bore which is substantially parallel to the threaded bore. The projection can be formed by a projecting peg, in particular a projecting straight pin or dowel pin, which engages either the groove or the bore. Alternatively, the projection is a shoulder which runs in a plane perpendicular to the connecting rod axis and engages the groove. The shoulder is generally to be understood as meaning an elongated, in particular flange-like, region which projects from the surface and extends at least partly in the circumferential direction, for example a collar, a step or a bead for absorbing axial forces on both sides between the connecting rod and the valve closure. In a further development of the invention, the shoulder has a cross-section which tapers outwards with respect to the shoulder in a substantially V-shaped manner and makes it possible for the closure disc to be centred relative to the. connecting rod in the directions of the displacement path in an interlocking manner by pressing the shoulder into the groove by means of the screw. In this case, the groove has a corresponding, in particular inward-tapering cross section.

Of course, further developments of the projection and/or the recess are possible.

The method according to the invention and the device according to the invention are described in more detail below purely by way of example with reference to specific working examples shown schematically in the drawings.

Specifically,

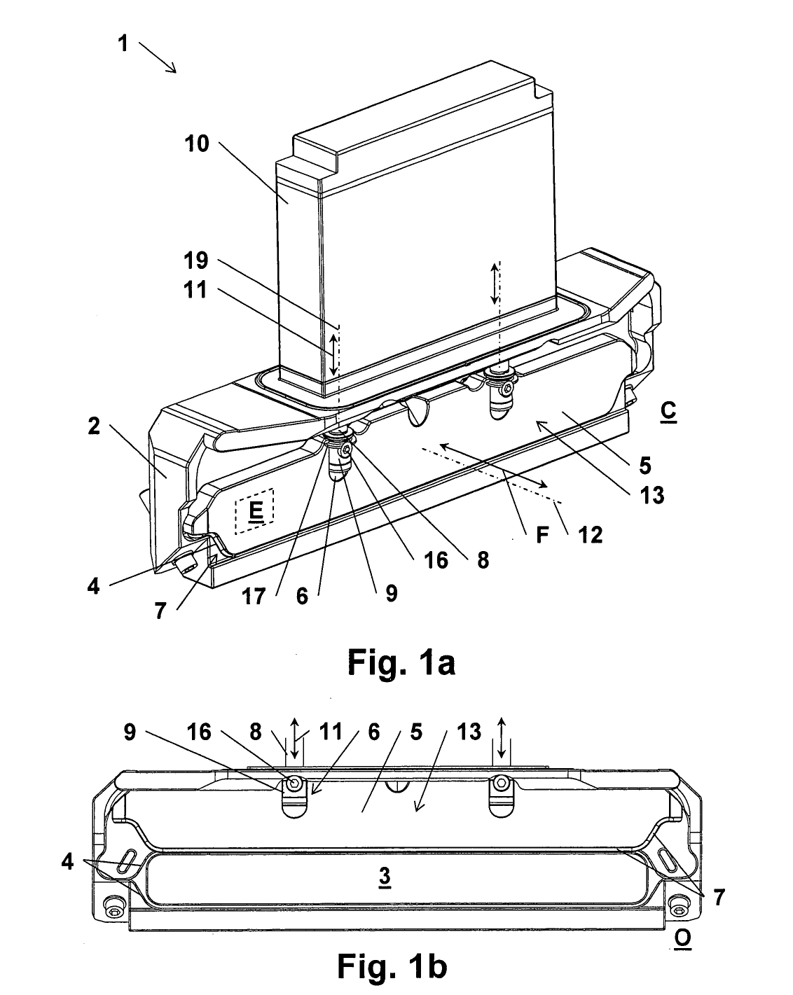

FIG. 1a shows an oblique view of a first vacuum valve comprising a closure disc in the closed position and a valve drive;

FIG. 1b shows a front view of the first vacuum valve from FIG. 1a comprising the closure disc in the open position without a valve drive;

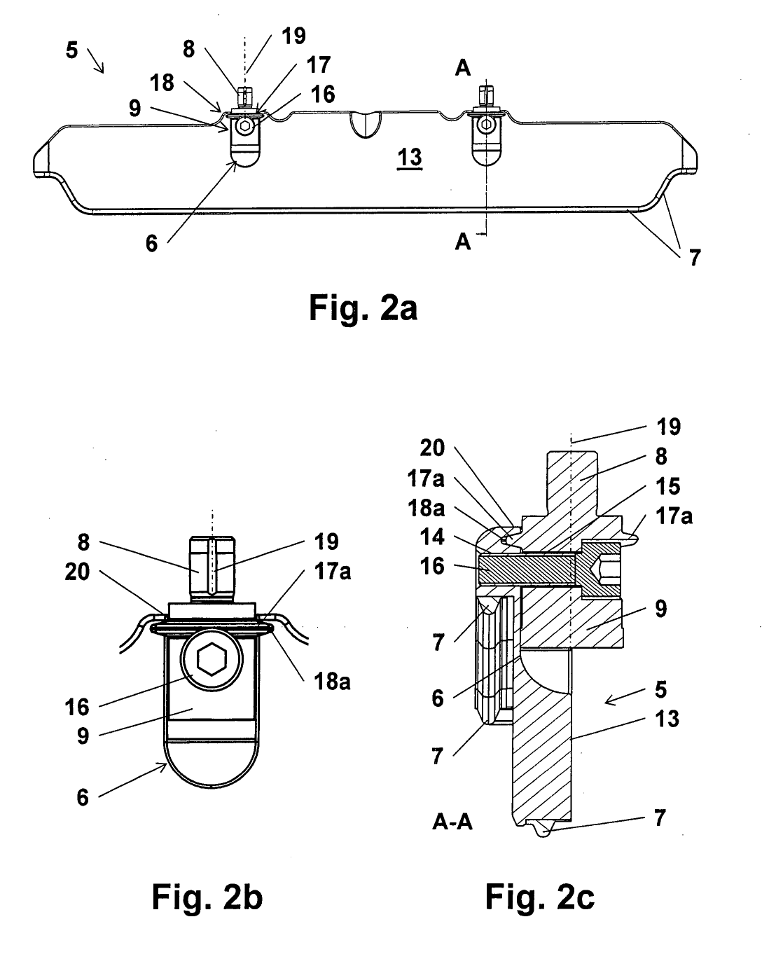

FIG. 2a shows a front view of the closure disc of the first vacuum valve from FIGS. 1a and 1b;

FIG. 2b shows a detailed view from FIG. 2a of the rod recess and the connecting section;

FIG. 2c shows a cross-sectional view from FIG. 2a of the rod recess and the connecting section;

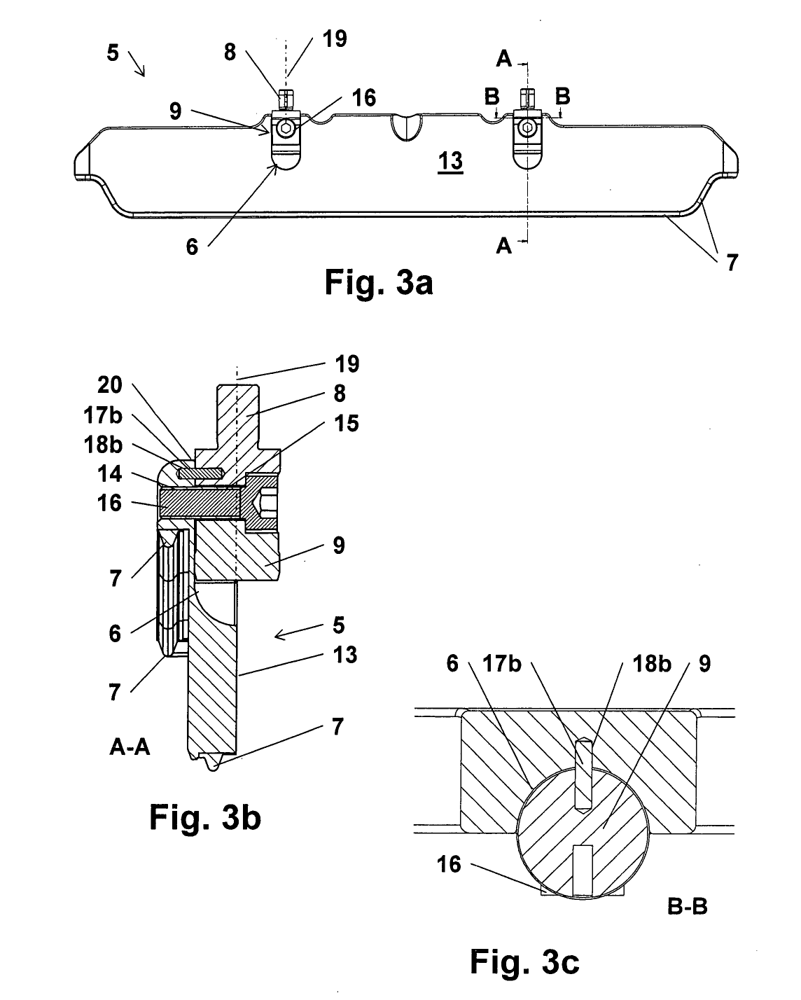

FIG. 3a shows a front view of a closure disc in a first alternative embodiment;

FIG. 3b shows a cross-sectional view A-A from FIG. 3a of the rod recess and the connecting section;

FIG. 3c shows a cross-sectional view B-B from FIG. 3a of the rod recess and the connecting section;

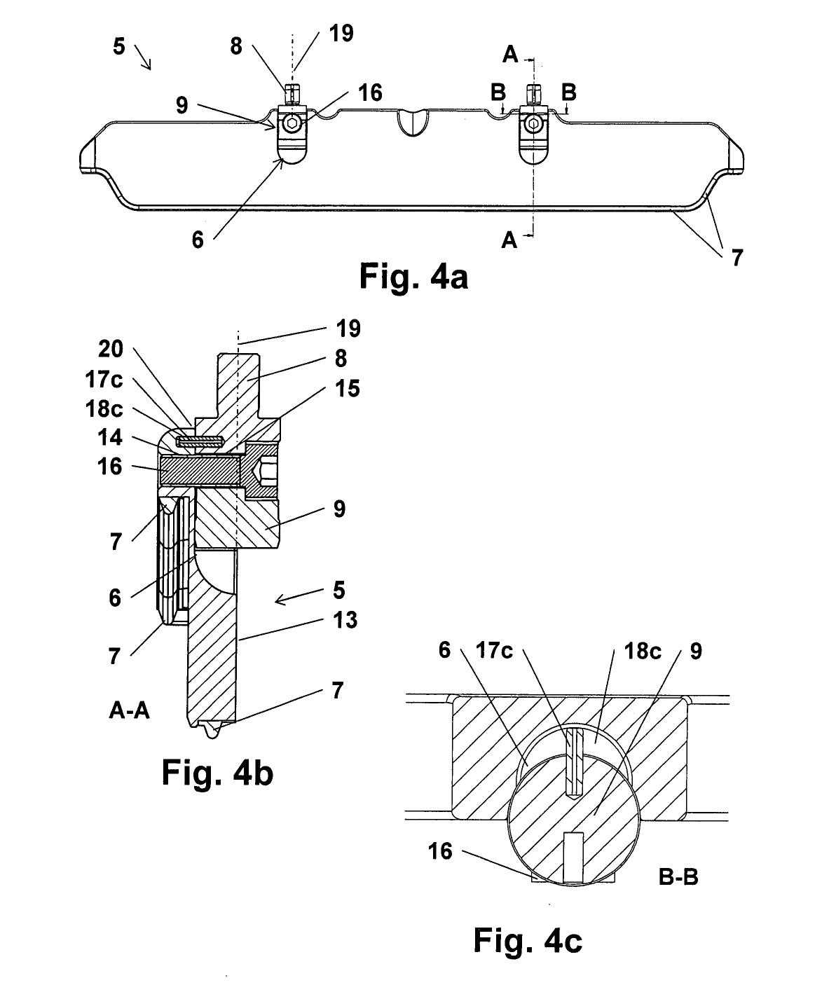

FIG. 4a shows a front view of a closure disc in a second alternative embodiment;

FIG. 4b shows a cross-sectional view A-A from FIG. 4a of the rod recess and the connecting section; and

FIG. 4c shows a cross-sectional view B-B from FIG. 4a of the rod recess and the connecting section.

FIGS. 1a to 2c show substantially a single embodiment of the invention in different views, states and degrees of detail, and it is for this reason that the figures are described together in some cases. FIGS. 3a to 3c and FIGS. 4a to 4c show in each case a first and a second alternative embodiment, respectively, of the vacuum valve, in each case in three views. Since in some cases, reference numerals are used for the figures and the embodiments differ partly in the details, reference numerals already explained beforehand will in part not be discussed again.

FIGS. 1a and 1b show a vacuum valve 1 in the form of a rectangular gate valve for the gas-tight closing of a flow path illustrated by means of the arrow F, in an oblique view and in a front view, respectively. FIGS. 2a, 2b and 2c show only the closure disc 5, including the ends of the connecting rods 8 of the vacuum valve 1 from FIGS. 1a and 1b. Below, these five figures are described together.

The vacuum valve 1 has a valve housing 2 having an opening 3 for the flow path F. The opening 3 has a rectangular cross-section with rounded corners. FIG. 1a shows the vacuum valve 1 in a closed position C, which is why the opening 3 is concealed and not visible, whereas the opening 3 is clearly recognizable in the opened position O of the vacuum valve 1 in FIG. 1b. The opening 3 has a central opening axis 12 which extends in the region of the opening 3 in the centre of the flow path F and parallel thereto. This opening axis 12 is perpendicular to the imaginary area defined by the opening. The opening 3 is enclosed by a valve seat surface 4 which curves around the opening 3 within a plurality of imaginary planes through which the opening axis 12 passes perpendicularly. The valve seat surface 4 points upwards in the direction of the valve drive 10.

Furthermore, the vacuum valve 1 comprises a flat closure disc 5. The closure disc 5 has a closure surface 7 which corresponds to the valve seat surface 4, points downwards in the direction of the valve seat surface 4 and likewise curves within a plurality of imaginary planes through which the opening axis 12 passes perpendicularly, as shown in a cross-section through the closure disc 5 in FIG. 2c. Two concave, namely semi-circular, rod recesses 6 which have a semi-circular channel shape are formed on that side 13 of the closure disc 5 which faces away from the opening 3. The two rod recesses 6 extend parallel within the closure disc plane E. A threaded bore 14 which is perpendicular to the closure disc plane E is provided in the middle inside the rod recesses 6, as shown in FIG. 2c, a cross section A-A through the rod recess 6 of the closure disc 5 according to FIG. 2a.

The closure disc 5 is removably mounted on two parallel connecting rods 8. The connecting rods 8 with their connecting sections 9 have a circular cross-section which corresponds to the partial cross-section of the rod recesses 6. The connecting rods 8 are linearly displaceable in a closure disc plane E perpendicular to the opening axis 12 by means of a valve drive 10 along a linear displacement path 11 which is parallel to the connecting rod axis 19. The imaginary closure disc plane E is shown schematically in the form of a rectangle, which illustrates the central plane E of the flat closure disc 5, in FIG. 1a. The two connecting sections 9 of the connecting rods 8 each have a transverse through-bore 15 which is arranged centrally in the connecting section 9, substantially perpendicular to the closure disc plane E, cf. FIG. 2c.

The closure disc 5 is removably mounted on the two connecting rods 8 by positioning of the rod recesses 6 on the connecting sections 9 by means of in each case a screw 16 led through the respective transverse bore 15 and engaging the respective threaded bore 14. The connecting section 9 is pressed by means of a screw 16 into the rod recess 6, cf. FIG. 2c.

The closure disc plane E is parallel to the area which is defined by the opening 3 and is not shown. The normals to the curved valve seat surface 4 and to the closure surface 7 which is a distance away which can be adjusted by means of the valve drive 10 and can be brought into contact are substantially parallel to the closure disc plane E, said normals not being shown. Thus, the valve seat surface 4 and the closure surface 7 are formed in such a way that, on closing of the vacuum valve 1, along the linear displacement path 11, the pressing of the closure surface 7 onto the valve seat surface 4 (cf. FIG. 1a) takes place substantially in a plane which is substantially parallel to the closure disc plane E, so that shear forces in a direction parallel to the opening axis 12 are completely or substantially avoided. The closure disc 5 is linearly displaced by means of the valve drive 10 along the displacement path 11 between an opened position O unblocking the opening 3 (cf. FIG. 1b) and a position C which is closed gas-tight and in which the closure disc is displaced linearly over the opening 3 and hence presses with the closure surface 7 in the closing direction of the displacement path 11 on to the valve seat surface 4, cf. FIG. 1a.

In the connecting sections 9 of the connecting rods 8, a projection 17 is formed in each case in the form of a shoulder 17a which extends around the connecting section 9 in a plane perpendicular to the connecting rod axis 19, cf. FIGS. 2a, 2b and 2c. The shoulder 17a has a substantially V-shaped cross-section tapering outwards with respect to the connecting rod 8, cf. FIGS. 2b and 2c. In the rod recess 6, a recess 18 in the form of a groove 18a, which is likewise in a plane perpendicular to the connecting rod axis 19, is arranged in a region between the threaded bore 14 and that edge 20 of the rod recess 6 which points towards the valve drive 10, cf. FIGS. 2b and 2c. The groove 18a extends in the circumferential direction along the entire rod recess 6. The shoulder 17a and the groove 18a are in the same plane, i.e. at the same height relative to the connecting rod 8. The projection 17 in the form of shoulder 17a and the recess 18 in the form of a groove 18a are formed in such a way that the shoulder 17a is gripped around by the groove 18a in an imaginary plane containing the connecting rod axis 19, and the closure disc 5 and the connecting rod 8 are fixed together in an interlocking manner in the directions of the displacement path 11, cf. FIG. 2c. The groove 18a has a cross-section tapering inwards, and the shoulder 17a a corresponding cross-section tapering outwards (cf. FIGS. 2b and 2c), such that, as a result of the pressing of the shoulder 17a into the groove 18a by means of the screw 16, the closure disc 5 is centred in an interlocking manner relative to the connecting rod 8 in the directions of the displacement path 11, as is also evident from FIGS. 2b and 2c. Thus, axial, interlocking fixing acting in both directions with respect to the connecting rod axes 19 exists between the connecting rods 8 and the closure disc 5.

After the initial firm tightening of the screw 16, the orientation of the closure disc 5 relative to the connecting rods 8 in the directions of the displacement path 11 thus takes place. Directly after mounting and even before the first closing of the vacuum valve 1, the closure disc 5 is exactly oriented on the connecting rods 8 so that material friction and the production of particles can be prevented immediately after the mounting of the closure disc 5 on the connecting rods 8. The closure disc 5 can be mounted on the connecting rods 8 of the valve drive 10 exactly with self-orientation and can be removed again, the existence of free material particles within the valve space, caused during operation of the vacuum valve 1, being kept low since, owing to the interlocking fit by pressing in, no relative movement can occur between the valve disc 5 and the connecting rods 8.

FIGS. 3a, 3b and 3c show a first alternative embodiment. FIGS. 3b and 3c show the cross-sections A-A and B-B, respectively, according to FIG. 3a through the rod recess 6 and the connecting section 9. Here, the recess 18 is in the form of a bore 18b which is substantially parallel to the threaded bore 14 in the rod recess 6 (cf. FIGS. 3b and 3c), the axes of the bore 18b and of the threaded bore 14 being on a common imaginary plane containing the connecting rod axis 19. The projection 17 is formed as a protruding peg in the form of a protruding straight pin 17b which is fixed in the connecting section 9 of the connecting rod 8, as likewise shown in FIGS. 3b and 3c. By introducing the straight pin 17b into the bore 18b on tightening of the screw 16, both axial interlocking fixation acting in both directions of the displacement path 11 with respect to the connecting rod axes 19 and radial interlocking fixation are created between the connecting rods 8 and the closure disc 5, so that both a linear relative movement in the directions of the displacement path 11 and any rotational movement about the connecting rod axis 19 are prevented.

FIGS. 4a, 4b and 4c show a second alternative embodiment. FIGS. 4b and 4c show the cross sections A-A and B-B, respectively according to FIG. 4a through the rod recess 6 and the connecting section 9. Here, the recess 18 is in the form of a sickle-shaped groove 18c which runs in the rod recess 6 in a plane perpendicular to the connecting rod axis 19. The projection 17 is formed as a protruding peg in the form of a protruding dowel pin 17c which is fixed in the connecting section 9 of the connecting rod 8. By introduction of the dowel pin 17c into the sickle-shaped groove 18c on tightening of the screw 16, axial interlocking fixation acting in both directions of the adjusting path 11 with respect to the connecting rod axes 19 is created between the connecting rods 8 and the closure disc 5, so that no linear relative movement in the directions of the displacement path 11 is possible. Instead of the dowel pin 17c, it is also possible to use the straight pin 17b of the first alternative embodiment, and vice versa. Furthermore, it is possible to use a normal groove 18a, as shown in the first working example, instead of the sickle-shaped groove 18c.

The specific working examples explained serve merely for exemplary illustration of the invention with reference to schematic diagrams. Of course, the invention is not limited to these working examples.

1. A vacuum valve for the gas-tight closing of a flow path, comprising
a valve housing having an opening for the flow path and a valve seat surface enclosing the opening all round,
a valve drive,
at least one connecting rod,
which is adjustable by means of the valve drive along a linear displacement path which is parallel to the connecting rod axis in a closure disc plane perpendicular to the opening axis, and
which has a connecting section having a transverse through-bore which is arranged centrally in the connecting section substantially perpendicularly to a closure disc plane, and
a closure disc which is removably mounted on the at least one connecting rod, comprising
a closure surface corresponding to the valve seat surface,
at least one concave—in particular semi-circular—rod recess which corresponds to the connecting section and is formed on that side of the closure disc which faces away from the opening, and
a threaded bore which is arranged centrally in the rod recess substantially perpendicularly to the closure disc plane,
the closure disc being removably mounted on the at least one connecting rod by positioning of the rod recess on the connecting section by means of a screw which is led through the transverse bore, engages the threaded bore and presses the connecting section into the rod recess,
the normals to the at least partly curved valve seat surface and to the closure surface being substantially parallel to the closure disc plane, and the closure disc being linearly displaceable by means of the valve drive along the displacement path between
an opened position (O) unblocking the opening and
a position which is closed gas-tight and in which the closure disc is linearly displaced over the opening and hence presses with the closure surface substantially in the closing direction of the displacement path onto the valve seat surface, wherein
a projection and a recess in the connecting region of the rod recess and of the connecting section, the projection and the recess being formed in such a way that the projection is gripped round by the recess in a plane containing the connecting rod axis, and the closure disc and the connecting rod being fixed to one another in an interlocking manner in the directions of the displacement path.

2. The vacuum valve according to claim 1, wherein the recess has a cross-section tapering in a manner such that the closure disc is centred in an interlocking manner relative to the connecting rod in the directions of the displacement path by pressing of the projection into the recess by means of the screw.

3. The vacuum valve according to claim 1, wherein the projection and the recess are arranged in a region between the threaded bore and that edge of the rod recess which points towards the valve drive.

4. The vacuum valve according to claim 1, wherein the projection is arranged in the connecting section and the recess is arranged in the rod recess.

5. The vacuum valve according to claim 1 4, wherein the recess is in the form of a groove which is in a plane perpendicular to the connecting rod axis.

6. The vacuum valve according to claim 5, wherein the groove has a cross-section tapering inwards into the groove in a substantially V-shaped manner.

7. The vacuum valve according to claim 1 4, wherein the recess is in the form of a bore which is substantially parallel to the threaded bore.

8. The vacuum valve according to claim 5, wherein the projection is in the form of a protruding peg, in particular of a protruding straight pin (17b) or dowel pin (17c).

9. The vacuum valve according to claim 5, wherein the projection is in the form of a shoulder (17a) which is in a plane perpendicular to the connecting rod axis.

10. The vacuum valve according to claim 9, wherein the shoulder (17a) has a cross-section tapering outwards in a substantially V-shaped manner with respect to the shoulder (17a).

11. The closure disc for a vacuum valve according to claim 1, the vacuum valve having, for the gas-tight closing of a flow path, a valve housing with an opening for the flow path and a valve seat surface, enclosing the opening all round, comprising
a closure surface which corresponds to the valve seat surface of the vacuum valve,
at least one concave—in particular semi-circular—rod recess
which is formed on that side of the closure disc which faces away from the opening, for receiving a connecting rod having a connecting rod axis along which the rod recess extends, and
having a threaded bore which is arranged centrally in the rod recess substantially perpendicularly to the closure disc plane,
on which connecting rod the closure disc can be removably mounted by positioning the rod recess on a connecting section of the connecting rod by means of a screw which engages the threaded bore and presses the connecting section into the rod recess,
and which connecting rod is adjustable by means of a valve drive along a linear adjusting path which is parallel to the connecting rod axis, in a closure disc plane perpendicular to the opening axis of the vacuum valve,
the normals to the at least partly curved valve seat surface and to the closure surface being substantially parallel to the closure disc plane, and the closure surface being formed in such a way that the closure surface can be pressed in the closing direction of the displacement path onto the valve seat surface to a position which is closed gas-tight and in which the closure disc is linearly displaced over the opening, wherein
a recess in the rod recess for gripping around a projection in the connecting section, the recess being formed in such a way that the projection is gripped around by the recess in a plane containing the connecting rod axis, and the closure disc and the connecting rod being capable of being fixed to one another in an interlocking manner in the directions of the displacement path.

12. The closure disc according to claim 11, wherein the recess is in the form of a groove which is in a plane perpendicular to the connecting rod axis.

13. The closure disc according to claim 12, wherein the groove extends along the entire rod recess.

14. The closure disc according to claim 12, wherein the groove has a cross-section tapering inwards into the groove in a substantially V-shaped manner.

15. The closure disc according to claim 11, wherein the recess is in the form of a bore which is substantially parallel to the threaded bore.

16. The closure disc according to claim 11, wherein the projection is arranged in a region between the threaded bore and that edge of the rod recess which points towards the valve drive.
